(19) United States
(12) Patent Application Publication
(10) Pub. No.: US 2002/0169910 A1
(43) Pub. Date: Nov. 14, 2002

(54) Queueing control system

(76) Inventor: Martin Stuart Christie, Castlethorpe (GB)

Correspondence Address: FAY, SHARPE, FAGAN, MINNICH & McKEE, LLP, 1100 Superior Avenue-Seventh Floor, Cleveland, OH, 44114-2518, US

(21) Appl. No.: 10/102,030

(22) Filed: Mar. 20, 2002

(30) Foreign Application Priority Data
Mar. 21, 2001 (GB) 0107179.4
Feb. 22, 2002 (GB) 0204136.6

(51) Int. Cl. G06F 13/24

(52) U.S. Cl. 710/263; 710/267; 710/244; 710/242

(57) ABSTRACT

A queueing control system including a control unit (2) and a plurality of call units (14) that are connected to the control unit (2), each said call unit (14) including a call switch (24) that, when activated by a customer, causes the call unit to transmit to the control unit a “call” signal that contains information uniquely identifying the call unit, the control unit (2) including means for recognising “call” signals received from the call units and placing the call units associated with those signals in a queue according to the order in which the “call” signals were received, the system further including display means (4) driven by the control unit that, in use, identifies the call unit that is at the front of the queue.

The present invention relates to a queueing control system and in particular, but not exclusively, to a queueing control system for use in bars and in other situations where customers wait at a counter to be served, but where they do not normally queue in an organised way.

Most people will be familiar with the difficulty of getting served at a busy bar or counter, where the server does not always know or take note of whose turn is next, and the customer has to rely on catching the server's attention, against competition from all the other customers who are waiting to be served. This problem can cause stress both for the customers and for the servers, and can spoil the atmosphere of the bar or counter.

Conventional queueing arrangements, for example using personnel barriers that make the customers queue in lines, or using ticketing arrangements, are not generally considered suitable for use in the relaxed and informal atmosphere of a bar. There is a need therefore for a queueing control system that ensures customers are served fairly and in turn, but without imposing a rigid queueing regime that would spoil the atmosphere of a bar or a similar situation in which customers are served at a counter.

It is an object of the present invention to provide a queueing control system that meets the aforesaid need.

According to the present invention there is provided a queueing control system including a control unit and a plurality of call units that are connected to the control unit, each said call unit including a call switch that, when activated by a customer, causes the call unit to transmit to the control unit a “call” signal that contains infonnation uniquely identifying the call unit, the control unit including means for recognising “call” signals received from the call units and placing the call units associated with those signals in a queue according to the order in which the “call” signals were received, the system further including display means driven by the control unit that, in use, identifies the call unit that is at the front of the queue.

The system allows a server to identify quickly who is to be served next, and provides a fair system of queueing for the customers, while avoiding competition and stress.

Advantageously, the display means is connected to the control unit and is constructed and arranged to indicate in use information identifying the call unit that is at the front of the queue. The display means may for example include a digital display that displays a number associated with the next call unit to be served. This may be mounted in a public location, so that it can be seen both by the servers and the customers. Additional slave displays may be provided in other locations.

Advantageously, each call unit includes a server display that is constructed and arranged to be activated by the control unit to indicate to a server that the call unit is at the front of the queue. For example, each call unit may include a LED indicator light that is illuminated when the call unit reaches the front of the queue.

Advantageously, each call unit includes a customer display that is constructed and arranged to be activated by the control unit, to indicate to a customer the position of that call unit in the queue. The customer unit may, for example, include a graphical display that indicates the length of the queue in front of that call unit.

Advantageously, each call unit includes a server switch that, when activated by a server, causes the call unit to transmit to the control unit a “clear” signal that contains information uniquely identifying the call unit, the control unit including means for recognising “clear” signals received from the call in its and removing the call units associated with those signals from the queue when those “clear” signals are received. This allows the server to remove a call unit from the queue when the person standing by that call unit has been served.

Advantageously, the call units are connected to the control unit through a data bus. Preferably, each call unit is connected to the data bus through a data link.

According to a preferred embodiment of the invention, there is provided a queueing control system for use at a bar or counter, wherein the call units are spaced along the bar or counter.

Embodiments of the invention will now be described, by way of example, with reference to the accompanying drawings, in which:

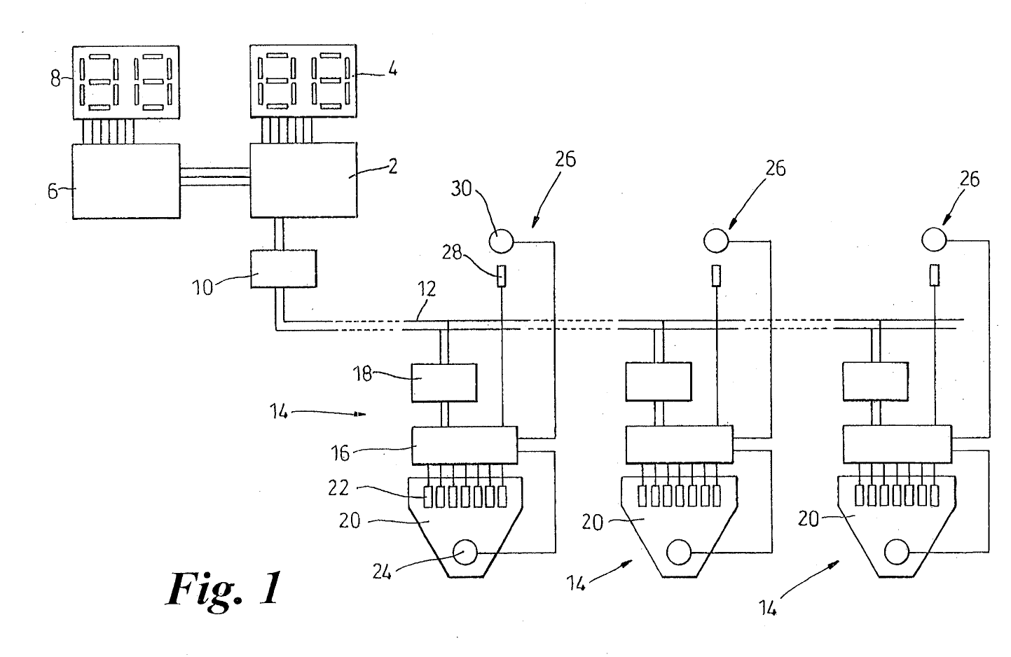

FIG. 1 is a schematic block diagram of a queueing control system;

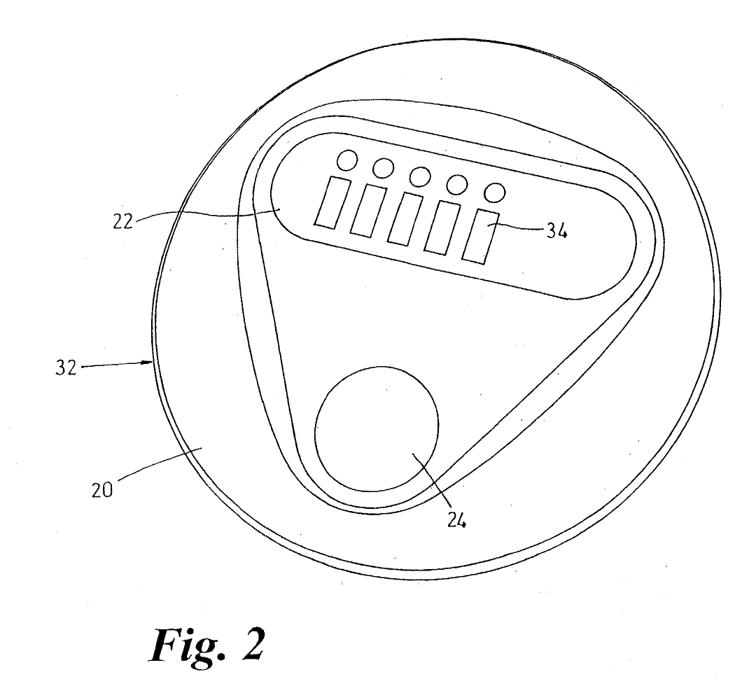

FIG. 2 is an isometric view of an indicator device forming part of the system;

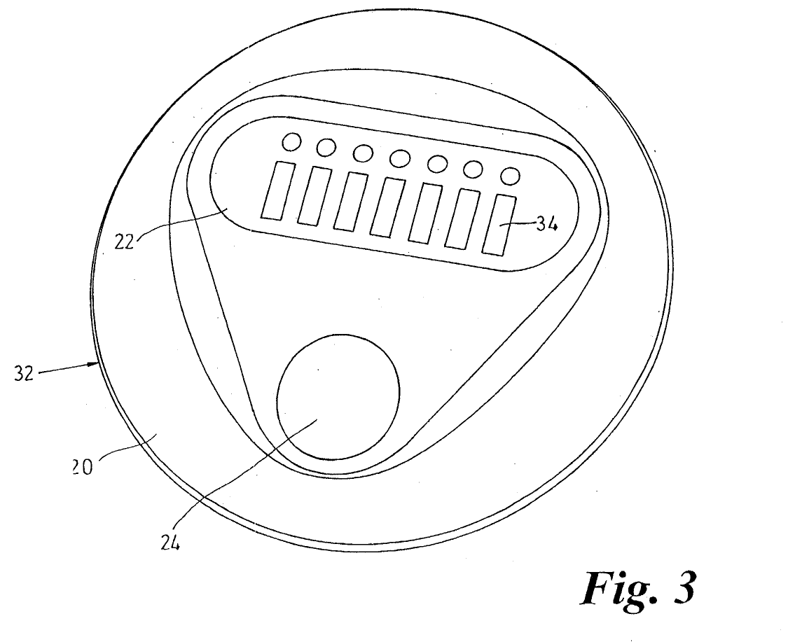

FIG. 3 is an isometric view of the indicator device, showing a variation in the display;

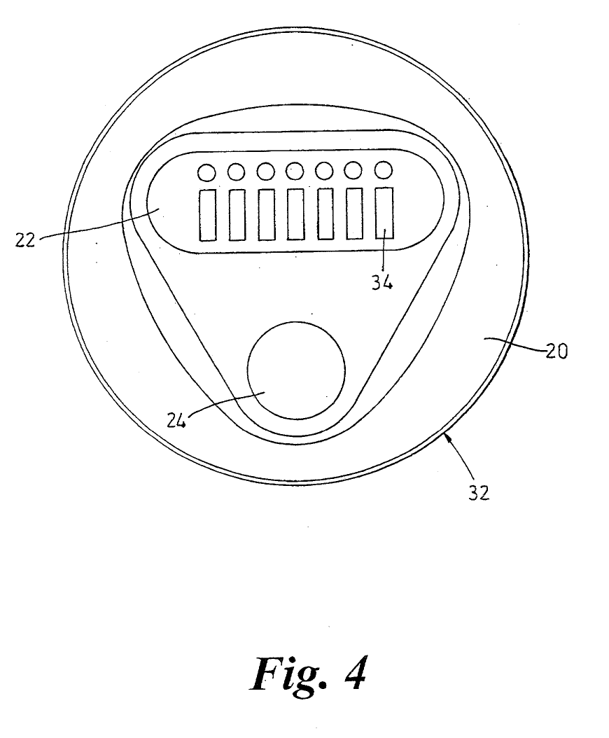

FIG. 4 is a top view of the indicator device; and

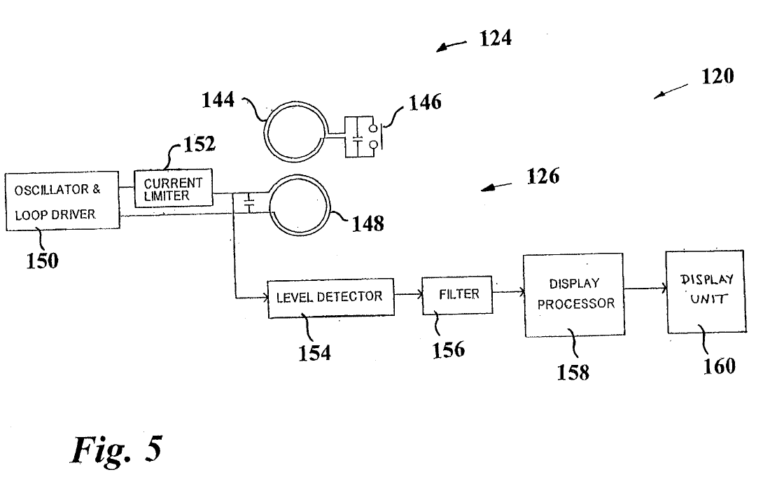

FIG. 5 is a schematic diagram of a customer call unit for use on glass counters.

The following example describes an implementation of the system in a drinks bar. It should be understood however that the system may also be implemented in other situations where customers wait to be served at a bar or counter, for example in shops, offices, hotels or other public buildings.

The system includes a system controller or control unit 2. This may be based around a microprocessor, which will include all the usual associated electronic components, such as volatile and non-volatile memories and input/output ports.

The system controller 2 is linked to a public display unit 4, for example an LED display, which in use indicates the next position to be served. The system controller may also be connected through a slave display driver 6 to one or more slave display units 8, located in different positions around the bar.

The system controller 2 is connected through a data link 10 to a data bus 12 that extends around the bar.

A plurality of call units 14 are dispersed around the bar. Preferably, enough call units 14 are provided so that even when the bar is crowded, every person standing or sitting at the bar has sole access to a call unit.

Each call unit 14 includes a control circuit 16, for example based around a microprocessor, that contains a unique identification code. The control circuit 16 is connected through a data link 18 to the data bus 12. Also connected to the control circuit 16 are a customer unit 20 that includes a customer display 22 and a customer call switch 24, and a server unit 26 that includes a server display 28 and a server switch 30.

The customer unit 20, which is shown in FIGS. 2 to 4, is mounted in a housing 32 that is attached to the bar and includes the call switch 24 and the customer display 22. The display 22 may for example consist of a small liquid crystal display device that, when activated, displays a number of FIGS. 34 representing the length of the queue waiting before the turn of the person using that customer unit. If the queue exceeds the length of the display, the display may change colour, as shown in FIG. 3.

The server unit 26 will also normally be mounted in the housing 32. In this case, the server display 28 and the server switch 30 may be provided on the back of the housing, where they are not normally seen by the customer. Alternatively, the server switch may be activated only by a key tag carried by the server, to prevent unauthorised activation by the customer. The server unit may alternatively be located separately but close to the customer unit, in a situation where the server switch 30 cannot be activated by the customer.

In operation, a customer wishing to be served stands at the bar adjacent one of the customer units 20 and presses the call switch 24. The control circuit 16 then sends a “call” signal containing the unique code identifying that call unit to the system controller 2 via the data bus 12. The controller recognises the unique code and places the call unit associated with that code in a virtual queue, behind any call units that have already been registered. The controller 2 assesses the length of the queue in front of the call unit that has just been registered and sends a signal indicating the length of the queue back to the call unit. The control circuit in the call unit activates the customer display to indicate the length of the queue to the customer.

Whenever a customer has been served, the server presses the server switch 30 on the call unit 14 associated with that customer. The control circuit 16 then sends a “clear” signal again containing the unique code identifying that customer unit to the system controller 2, via the data bus 12. The controller recognises the unique code and removes the call unit associated with that code from the virtual queue, at the same time advancing any other registered call units one place forward in the queue. The controller sends a signal to each of the registered call units, each of which then adjusts the image displayed on the customer display 22, to indicated the reduced length of the queue.

At the same time, an identifying number associated with the call unit now at the head of the queue is indicated on the main display 4 and, if provided, any slave displays 8, and a further signal is transmitted to the call unit now at the head of the queue, activating the server display 28. These indications show the server and the customer who is to be served next.

Once a call unit has been removed from the virtual queue, the call switch 24 can be pressed again. The call unit will then be placed back in the virtual queue.

FIG. 5 shows an alternative customer unit 120 for use on glass counters. Glass counters are becoming increasingly popular, especially for displaying goods. However, it is generally undesirable to drill holes for wiring in glass counter and the customer unit shown in FIG. 5 is designed to avoid this need.

The customer unit includes an above-glass unit 124 and a below-glass unit 126. The above-glass unit 124 includes an inductor/capacitor tuned circuit 144 and a switch 146, for example a push button switch. The below-glass unit 126 includes an inductor/capacitor loop 148that is driven by an oscillator 150,a current limiter 152,a level detector 154, filter 156, a display processor 158 and a customer display unit 160. The upper and lower loops 144, 148 are positioned in close proximity to each other on either side of the glass so that they are inductively linked. The display unit 160 is visible through the glass counter: for example, the above glass unit 124 may include a window through which the display unit can be seen. The customer unit 120 is linked to a system controller as in the arrangement shown in FIG. 1 by means of a data link (not shown) from the display processor 158.

In operation, the oscillator 150 drives the lower loop 148 through the current limiter 152. The above-glass inductor/capacitor tuned circuit 144 is timed to load the below-glass inductor/capacitor loop such that the signal 158 after the current limiter 152 is small. When the switch 146 is pressed, the above-glass circuit 144 is de-tuned and no longer loads the below-glass loop 148. The signal 158 after the current limiter 152 rises and is detected by the level detector 154. The signal is filtered and passed via the display processor 158 to the system controller, which recognises the signal and places the call unit associated with that signal in the virtual queue. At the same time, the customer display unit 160 is activated to indicate, for example, the position of the customer in the queue.

Various modifications of the system are of course possible, some of which will now be described.

The customer display may include a simple numerical display instead of the graphical display shown in the drawings, or it may be arranged to display other information, such as instructions (e.g. “PRESS FOR SERVICE”) or promotional messages and advertisements. The call unit may also include a small video screen for displaying advertisements and other material while the customer is waiting.

The queueing system may also include an audible or visual alarm, to alert serving staff to the fact that a customer is waiting, or to call additional servers when the bar is very busy.

While the primary purpose of the invention is to enable queueing, it may also be used to collect data, which may be used later to analyse the performance of the bar and the serving staff, for example to identify staff who are under-performing or parts of the bar that receive inadequate service.

1. A queueing control system including a control unit and a plurality of call units that are connected to the control unit, each said call unit including a call switch that, when activated by a customer, causes the call unit to transmit to the control unit a “call” signal that contains information uniquely identifying the call unit, the control unit including means for recognising “call” signals received from the call units and placing the call units associated with those signals in a queue according to the order in which the “call” signals were received, the system further including display means driven by the control unit that, in use, identifies the call unit that is at the front of the queue.

2. A queueing control system according to claim 1, wherein the display means is connected to the control unit and is constructed and arranged to indicate in use an identification code identifying the call unit that is at the front of the queue.

3. A queueing control system according to claim 1, wherein each call unit includes a server display that is constructed and arranged to be activated by the control unit to indicate to a server that the call unit is at the front of the queue.

4. A queueing control system according to claim 1, wherein each call unit includes a customer display that is constructed and arranged to be activated by the control unit, to indicate to a customer the position of the call unit in the queue.

5. A queueing control system according to claim 1, wherein each call unit includes a server switch that, when activated by a server, causes the call unit to transmit to the control unit a “clear” signal that contains information uniquely identifying the call unit, the control unit including means for recognising “clear” signals received from the call units and removing the call units associated with those signals from the queue when those “clear” signals are received.

6. A queueing control system according to claim 1, wherein the call units are connected to the control unit through a data bus.

7. A queueing control system according to claim 6, wherein each call unit is connected to the data bus through a data link.

8. A queueing control system according to claim 1 for use at a bar or counter, wherein the call units are spaced along the bar or counter.
